(19) United States
(12) Patent Application Publication
(10) Pub. No.: US 2020/0372494 A1
(43) Pub. Date: Nov. 26, 2020

(54) Transferring Funds Between Wallet Client Accounts

(71) Applicant: Wells Fargo Bank, N.A., San Francisco, CA (US)

(72) Inventors: Ramanathan Ramanathan, Bellevue, WA (US); Joon Maeng, Newcastle, WA (US); Thomas B. Hayes, Katy, TX (US)

(21) Appl. No.: 15/354,566

(22) Filed: Nov. 17, 2016

(51) Int. Cl. G06Q 20/36; G06Q 20/38; G06Q 20/32

(52) U.S. Cl. CPC G06Q 20/3674; G06Q 2220/00; G06Q 20/3226; G06Q 20/3829

(57) ABSTRACT

An example method for processing a payment from a first user to a second user includes receiving a request for an electronic payment to the second user. A payment authorization is sent to a second server computer. A second request is received from the second server computer to process the electronic payment. The second request includes the payment token and a financial account identifier for the second user. A dollar amount of the electronic payment is obtained from the payment token. A session identifier is obtained at the first server computer. When a determination is made that the session identifier is an identifier for an active session and that a financial account identifier for the second user is for a financial account at a financial institution associated with the server computer, the dollar amount of the electronic payment is credited to the financial account for the second user.

### BACKGROUND

Payment cards are commonly used to purchase goods and services in retail stores and on the Internet. When paying for goods or services at a retail store, a card reader can be used to obtain authentication information from the payment card. An electronic payment transaction including the authentication information and information regarding the payment is then encrypted and sent over a private payment network for payment processing. A payment process including the electronic payment transaction and the private payment network can be complicated and expensive.

Electronic payments can also be made between individuals. The electronic payments between individuals can also be made over a private payment network. A payment process including electronic payments between individuals using the private payment network can also be complicated and expensive.

### SUMMARY

Embodiments of the disclosure are directed to a method implemented on a first server computer for processing a payment from a first user to a second user. The method comprises: receiving a first request from a first electronic computing device to initiate a process for making an electronic payment from the first user at the first electronic computing device to the second user at a second electronic computing device; sending a payment authorization to a second server computer, the payment authorization specifying a dollar amount of the electronic payment; receiving a second request from the second server computer to process the electronic payment, the second request including a payment token and a financial account identifier for the second user; obtaining the dollar amount of the electronic payment from the payment token; obtaining a session identifier at the first server computer; determining whether the session identifier is an identifier for an active session; determining whether the financial account identifier for the second user is for a financial account at a first financial institution associated with the first server computer; and when a determination is made that the session identifier is an identifier for an active session and when a determination is made that the financial account identifier for the second user is for the financial account at the first financial institution associated with the first server computer, crediting the dollar amount of the electronic payment to the financial account for the second user at the first financial institution.

In another aspect a method implemented on a first electronic computing device for initiating a monetary payment from a first user on the first electronic computing device to a second user on a second electronic computing device comprises: sending a payment request to a first server computer; as a result of sending the payment request to the first server computer, receiving from a second server computer a session key and a payment token; and sending a payment message to the second electronic computing device to initiate the monetary payment to the second user on the second electronic computing device, wherein the payment message includes the payment token.

In yet another aspect, a first server computer comprises: a processing unit; and system memory, the system memory including instructions which, when executed by the processing unit, cause the first server computer to: receive a first request from a first mobile electronic computing device to initiate a process for making an electronic payment from a first user at the first mobile electronic computing device to a second user at a second mobile electronic computing device; send a session identifier and a payment token to the first mobile electronic computing device, the payment token specifying a dollar amount of the electronic payment; receive a second request from the second mobile electronic computing device to process the electronic payment, the second request including the payment token and a financial account identifier for the second user; obtain the payment token from the second request; obtain the dollar amount of the electronic payment from the payment token; determine whether the session identifier is an identifier for an active session; determine whether the financial account identifier for the second user is for a financial account at a first financial institution associated with the first server computer; when a determination is made that the session identifier is an identifier for an active session and when a determination is made that the financial account identifier for the second user is for the financial account at the first financial institution associated with the first server computer, credit the dollar amount of the electronic payment to the financial account for the second user at the first financial institution; when a determination is made that the financial account identifier for the second user is not for the financial account at the first financial institution and a determination is made that the session identifier is active, send a third request to process the payment token to a second server computer associated with a second financial institution at which the second user has one or more financial accounts; and when a determination is made that the session identifier is not an identifier for an active session, cancel the electronic payment.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a secure transfer of funds between wallet clients using an email system.

FIG. 2 shows example modules of the mobile wallet service provider server computer of FIG. 1.

FIG. 3 shows example modules of the payment issuing financial institution server computer of FIG. 1.

FIG. 4 shows an example format of a payment request email message sent to a mobile wallet service provider.

FIG. 5 shows a method for initiating a funds transfer from a mobile electronic computing device of FIG. 1.

FIG. 6 shows a method for processing a payment message for a funds transfer at another mobile electronic computing device of FIG. 1.

FIG. 7 shows a method for processing a funds transfer request at the mobile wallet service provider server computer of FIG. 1.

FIG. 8 shows a flowchart for processing a funds transfer request at the payment issuing financial institution server computer of FIG. 1.

FIG. 9 shows example physical components of the mobile wallet service provider server computer of FIG. 1.

### DETAILED DESCRIPTION

The present disclosure is directed to systems and methods for securely implementing electronic payments between individuals.

In some examples, the electronic payments can be made using a digital wallet client on a mobile electronic computing device of a first individual and sent to a digital wallet client on a mobile electronic computing device of a second individual. The electronic payments are secured using a payment token that authorizes an electronic payment and by a session key that can be used to encrypt the payment token. The session key and the payment token can be obtained from a mobile wallet service provider. A method of exchange messages, such as email, can be used to transmit the encrypted payment token and other information between devices. In this disclosure, the first individual is also referred to as the payer and the second individual is also referred to as the payee.

The mobile wallet service provider, a financial institution server computer the payer, and the mobile electronic computing devices of the payer can be part of a federated single sign-on system. The payer can request and obtain a single sign-on identifier from the mobile wallet service provider. The payer can use the single sign-on identifier to login to the financial institution server computer and to authorize the electronic payment on the financial institution server computer. In response, the financial institution server computer can send a payment token to the mobile wallet service provider. The payment token can authorize the electronic transaction. The mobile wallet provider can generate a session identifier for the electronic transaction and a session key that can be used to encrypt the payment token. The mobile wallet provider can send the session identifier, the session key and the payment token to the mobile electronic computing device of the payer. The mobile wallet provider does not encrypt the payment token.

The mobile electronic computing device of the payer can use the session key to encrypt the payment token and send the encrypted payment token to the mobile electronic computing device of the payee. As explained in more detail later herein, the mobile electronic computing device of the payee can send the encrypted payment token to the mobile wallet service provider. The mobile wallet service provider can in turn use the payment token to request payment from the financial institution server computer. As long as the session identifier is active, the payment token permits the financial institution server computer to complete the electronic payment. When the payee has a financial account at the financial institution, the financial institution server computer can immediately complete the payment transaction. However, when the payee does not have a financial account at the financial institution, a payment request, typically an automatic clearing house (ACH) payment request, is sent from the financial institution server computer of the payer to a financial institution server computer of the payee in order to complete the payment transaction.

The systems and methods disclosed herein are directed to a computer technology that can securely implement an electronic transfer of funds from a payer to a payee using standard email messages. The use of standard email messages during a secure financial funds transfer obviates the need to use dedicated, secure lines to implement the funds transfer. This results in a more efficient funds transfer at a lower cost.

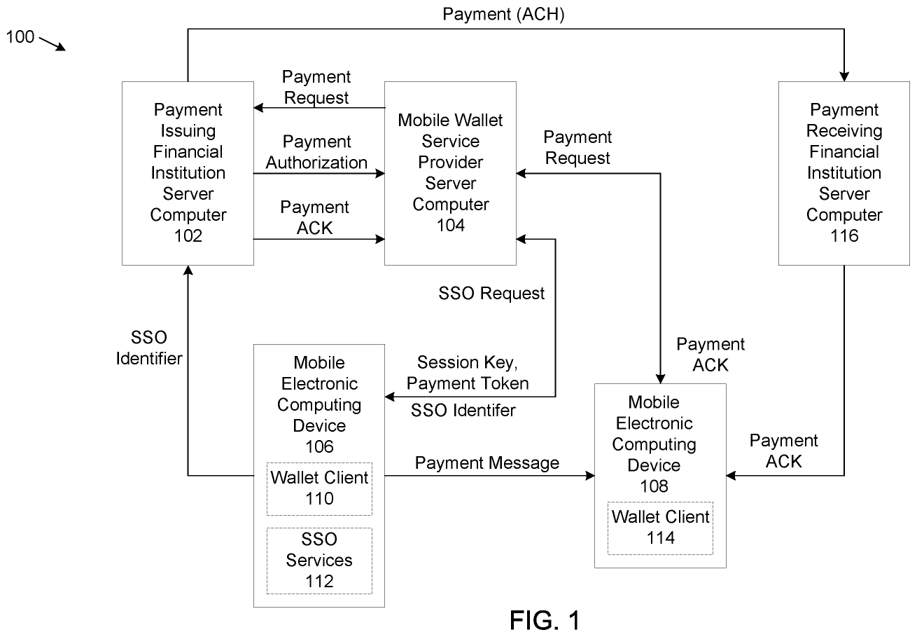

FIG. 1 shows an example system 100 that can support a secure transfer of funds between wallet clients using an email system. The example system 100 includes a payment issuing financial institution server computer 102, a mobile wallet service provider server computer 104, mobile electronic computing device 106, mobile electronic computing device 108 and payment receiving financial institution server computer 116. Mobile electronic computing device 106 includes a wallet client 110 and a single sign-on (SSO) services module 112. Mobile electronic computing device 108 includes a wallet client 114.

The example payment issuing financial institution server computer 102 is a server computer of a financial institution, such as a bank. In system 100, the payment issuing financial institution server computer 102 is a server computer at a financial institution at which the payer of the funds has a financial account.

The example mobile wallet service provider server computer 104 is a server computer at a provider of mobile wallet services. The provider of mobile wallet services is a centralized, federated payment system for mobile wallet clients. As explained in more detail later herein, the mobile wallet service provider server computer 104 can provide a session identifier, a session key and a payment token to a payer mobile wallet client (wallet client 110). The payer mobile wallet client can encrypt the payment token with the session key to securely transfer funds to a payee mobile wallet client (wallet client 114). The mobile wallet service provider can also provide a single sign-on identifier that can be used by the payer mobile wallet client. In some implementations, the single sign-on identifier can be used as the session identifier. The mobile wallet server provider can also process payment requests from the payee mobile wallet client.

The example mobile electronic computing device 106 is a mobile electronic computing device such as a smartphone, a tablet computer or a laptop computer. For example system 100, the mobile electronic computing device 106 is a smartphone used by the payer to transfer funds to the payee.

The example wallet client 110 is a digital wallet software application that is installed on mobile electronic computing device 106. Wallet client 110 can permit the payer at mobile electronic computing device 106 to make electronic transactions using mobile electronic computing device 106. The electronic transactions can include purchasing an item at a retail store and transferring funds from a financial account of the payer to the payee.

The example SSO services module 112 can initiate a single sign-on process on mobile electronic computing device 106. A login request can be made to mobile wallet service provider server computer 104 to login to a federated single sign-on service hosted on mobile wallet service provider server computer 104. The login request can include a user ID and a password. When the user is authenticated at mobile wallet service provider server computer 104, mobile wallet service provider server computer 104 can send a SSO identifier to the SSO services module 112. The SSO identifier can be used to authenticate the payer at payment issuing financial institution server computer 102 without the need for the payer to reenter the user ID and password at financial institution server computer 102.

The example mobile electronic computing device 108 is a mobile electronic computing device such as a smartphone, a tablet computer or a laptop computer. For example system 100, the mobile electronic computing device 106 is a smartphone used by the payee to receive funds transferred from the payer on mobile electronic computing device 106.

The example wallet client 114 is a digital wallet software application that is installed on mobile electronic computing device 108, similar to the digital wallet software application that is installed on mobile electronic computing device 106. Wallet client 114 can permit the payee at mobile electronic computing device 108 to make electronic transactions using mobile electronic computing device 108. The electronic transactions can include receiving a transfer of funds from the financial account of payer.

The example payment receiving financial institution server computer 116 is a server computer at a financial institution, such as a bank. In the example system 100, as discussed in more detail later herein, the payment receiving financial institution server computer 116 is used to receive a transfer of funds from the payer when the payee at mobile electronic computing device 108 does not have a financial account at the payment issuing financial institution server computer 102. When the payee does have a financial account at the payment issuing financial institution server computer 102, the payment receiving financial institution server computer 116 is not used during the transfer of funds to the payee.

Operationally, the payer at mobile electronic computing device 106 can login to wallet client 110 and initiate a transfer of funds to the payee at mobile electronic computing device 108. For example, the payer can login to wallet client 110 using a user ID and password. After login, mobile electronic computing device 106 can send an SSO request to mobile wallet service provider server computer 104. The SSO request includes a request for a single sign-on (SSO) identifier. In response, the mobile wallet service provider server computer 104 sends the SSO identifier to mobile electronic computing device 106. The SSO identifier can authorize a login to payment issuing financial institution server computer 102.

The payer at mobile electronic computing device 106 can use the SSO identifier to single sign-on to payment issuing financial institution server computer 102 and request a payment of funds to the payee. The request can include an amount of the funds to be transferred from the financial account of the payer.

When the payment issuing financial institution server computer 102 receives the SSO identifier and the request for the payment of funds, the payment issuing financial institution server computer 102 issues a payment authorization to mobile wallet service provider server computer 104. Mobile wallet service provider server computer 104 in turn issues a session identifier (session ID), a session key and a payment token to mobile electronic computing device 106. In some implementations, the SSO identifier can be used as the session ID. The session ID identifies an active session that can be used for a funds transfer from the payer to the payee. The payment token provides an authorization for the funds transfer. The session key can be used by wallet client 110 to encrypt the payment token. The session key can comprise part of a symmetrical encryption method, whereby the session key can be used to both encrypt and decrypt the payment token. In some implementations, the session key can be sent to the mobile electronic computing device separately from the payment token.

When mobile electronic computing device 106 receives the session ID, the session key and the payment token, mobile electronic computing device 106 can send a payment message to mobile electronic computing device 108. The payment message can include the session ID, the encrypted payment token, an identifier of the payee and an identifier for the financial institution at which the payer has a financial account and from which the funds are to be transferred. The identifier of the payee can be an identifier such as a name or ID that clearly identifies the payee. The identifier of the financial institution of the payer can be a name or other identifier, for example a URL, of the financial institution of the payer.

The payment message from mobile electronic computing device 106 to mobile electronic computing device 108 can be in one of several formats. In one implementation, the payment message can comprise an email message. In another implementation, when mobile electronic computing device 106 and mobile electronic computing device 108 are in close proximity, the payment message can comprise a message sent over a near-field communication (NFC) interface. In each implementation the payment token can be encrypted using the session key and the encrypted payment token can be sent to mobile electronic computing device 108.

When the encrypted payment token is received at mobile electronic computing device 108, wallet client 114 generates a payment request to mobile wallet service provider server computer 104. The payment request comprises a first email message that includes a financial account identifier for the payee and also includes an embedded second email message addressed to payment issuing financial institution server computer 102. The second email message includes the encrypted payment token. The first email message is encrypted with a public key of the mobile wallet service provider server computer 104 and sent to mobile wallet service provider server computer 104.

When mobile wallet service provider server computer 104 receives the first email message, mobile wallet service provider server computer 104 decrypts the first email message using a private key of mobile wallet service provider server computer 104. Mobile wallet service provider server computer 104 obtains the financial account identifier for the payee and the encrypted payment token from the first email message, decrypts the payment token using the session key, appends the financial account identifier for the payee and the decrypted payment token to the second email message, encrypts the second email message using a public key for mobile wallet service provider server computer 104 and sends the encrypted second email message as a payment request to payment issuing financial institution server computer 102 for payment processing.

When payment issuing financial institution server computer 102 receives the payment request, payment issuing financial institution server computer 102 decrypts the encrypted second email message with a private key of payment issuing financial institution server computer 102 and obtains the financial account identifier of the payee, the payment token and the session ID.

The payment issuing financial institution server computer 102 determines whether the financial account of the payee is at the same financial institution as the financial account of the payer. When the financial institution of the payee and the payer are the same, the payment issuing financial institution server computer 102 determines whether the session ID is an active session ID. When the session ID is determined to be an active ID, payment issuing financial institution server computer 102 can complete the funds transfer from the payer to the payee. The payment issuing financial institution server computer 102 can then send a payment acknowledgment (payment ACK) to mobile wallet service provider server computer 104 and mobile wallet service provider server computer 104 can in turn send the payment ACK to mobile electronic computing device 108 to complete the funds transfer.

When the financial institution of the payee and the payer are not the same, payment issuing financial institution server computer 102 cannot complete the funds transfer from the payer the payee. Instead, payment issuing financial institution server computer 102 sends an ACH payment to the financial institution of the payee, in this example to payment receiving financial institution server computer 116. When the funds transfer is completed, payment receiving financial institution server computer 116 sends a payment ACK to mobile electronic computing device 108.

Various schemas can be used for messaging used during the operation of system 100. In an example schema, when the when mobile electronic computing device 106 sends an SSO request for a SSO identifier to mobile wallet service provider server computer 104, a request message from mobile electronic computing device 106 can include the following schema:

[message header] [message body], where
[message header] can include a From: email address for mobile electronic computing device 106, a To: email address for mobile wallet service provide 104 and a Subject: Request SSO Identifier and
[message body] can be blank

When mobile wallet service provider 104 sends a response to the SSO request, a response message from mobile wallet service provider 104 can include the following schema:

[message header] [message body], where
[message header] can include a From: email address for mobile wallet service provider 104, a To: email address for mobile electronic computing device 106 and a Subject: SSO Identifier Response and
[message body] can be [SSO Identifier]

When mobile wallet service provider 104 sends a response to a payment authorization from payment issuing financial institution server computer 102, a response message from mobile wallet service provider 104 can include the following schema:

[message header] [message body], where
[message header] can include a From: email address for mobile wallet service provider 104, a To: email address for mobile electronic computing device 106 and a Subject: Payment Authorization Response and
[message body] can be [session key] [payment token], where
   [session key] can be a unique number and
   [payment token] can include an authorization code and a payment amount

A similar schema structure can be used for other messages sent between devices in system 100. In addition, other schemas can be used.

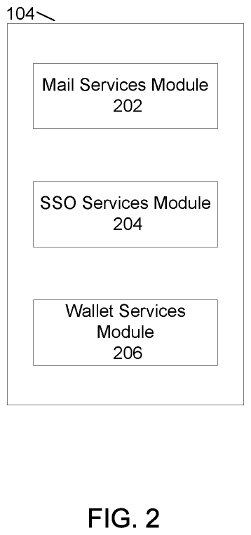

In an alternate implementation, instead of using a separate session ID and SSO identifier, the SSO identifier can be used as the session ID. The SSO identifier is known by payment issuing financial institution server computer 102, mobile wallet service provider server computer 104 and mobile electronic computing device 106 and can permit a user at mobile electronic computing device 106 to login to payment issuing financial institution server computer 102 and mobile wallet service provider server computer 104. In this alternate implementation, the session ID is active as long as the user remains logged in to financial institution server computer 102 and to mobile wallet service provider server computer 104. FIG. 2 shows example modules of the mobile wallet service provider server computer 104. The example mobile wallet service provider server computer 104 includes a mail services module 202, a SSO services module 204 and a wallet services module 206. More, fewer or different modules are possible.

The example mail services module 202 implements a mail transfer agent and a mail delivery agent that transfers electronic mail messages to and from mobile electronic computing device 106, mobile electronic computing device 108 and payment issuing financial institution server computer 102 using a client/server architecture.

The example SSO services module 204 implements the federated single sign-on service for mobile electronic computing device 106 and payment issuing financial institution server computer 102. The federated aspect of the federated single sign-on service permits user single sign-on credentials to be stored on or accessed from mobile wallet service provider server computer 104. The single sign-on aspect of the federated single sign-on service permits a user to use on set of login credentials (e.g. a user ID and password) to access multiple applications. For example, the user of mobile electronic computing device 106 can use a single set of login credentials to login to both mobile wallet service provider server computer 104 and payment issuing financial institution server computer 102. In particular, when the payer at mobile electronic computing device 106 logs in to mobile wallet service provider server computer 104 via a SSO request, the SSO services module generates a SSO identifier that the payer can use to be authenticated at payment issuing financial institution server computer 102.

The example wallet services module 206 implements a digital wallet service on mobile wallet service provider server computer 104. The digital wallet service permits users to store and control online shopping information such as logins, passwords, shipping addresses and credit card details in one central location. The central location can be on mobile wallet service provider server computer 104 or on another computer or database that is accessible from mobile wallet service provider server computer 104. The wallet services module 206 can also implement money transfers between individuals by processing fund transfer requests from mobile wallet clients and interfacing with host systems to request and receive payment tokens and session identifiers that can be used for the fund transfers.

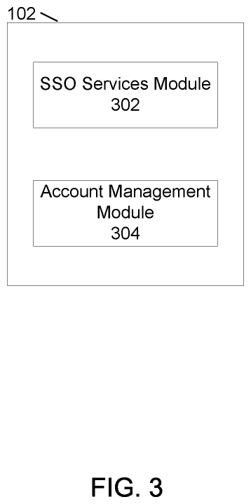

FIG. 3 shows example modules of payment issuing financial institution server computer 102. The example modules include a SSO services module 302 and an account management module 304. More, fewer or different modules are possible.

The example SSO services module 302 processes single sign-on login requests from the user at mobile electronic computing device 106. For the example system 100, the single sign-on request comprises a SSO identifier generated by the mobile wallet service provider server computer 104. Because payment issuing financial institution server computer 102 is a part of the federated single sign-on service hosted on mobile wallet service provider server computer 104, the SSO services module 302 can recognize the SSO identifier to authenticate the payer at payment issuing financial institution server computer 102.

The example account management module 304 provides access to the payer's financial accounts on the payment issuing financial institution server computer 102. The account management module 304 also processes payment requests from the payer and generates a payment authorization to the mobile wallet service provider server computer 104. The account management module 304 also processes payment requests for funds to be transferred out of a financial account of the payer and issues a payment acknowledgement when a fund transfer is completed. As discussed earlier herein, when the payment request is from a payee that also has an account on payment issuing financial institution server computer 102 and a determination is made that a session ID is active for the funds transfer, the account management module 304 can complete the funds transfer on payment issuing financial institution server computer 102. Completing the funds transfer can comprise debiting the financial account of the payer for the amount of the funds transfer and crediting the financial account of the payee.

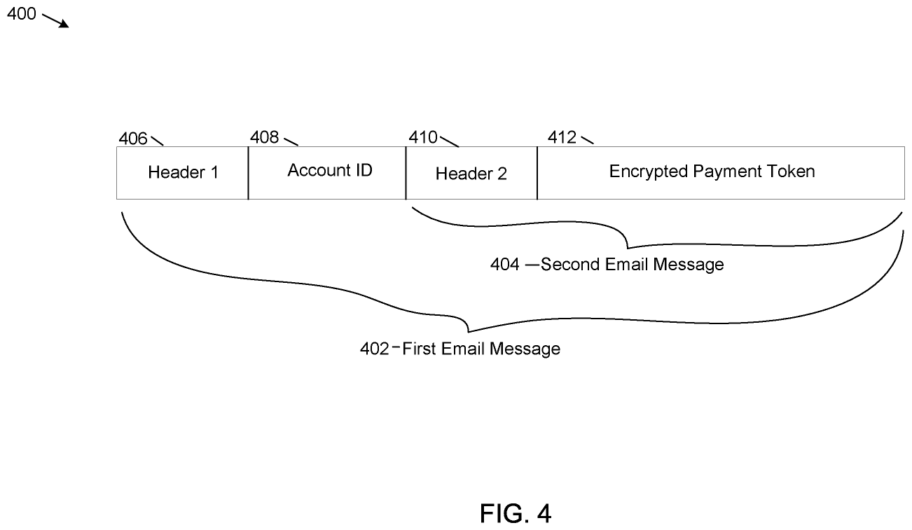

FIG. 4 is an example format 400 of the payment request email message sent from mobile electronic computing device 108 to mobile wallet service provider server computer 104. The example payment request email message includes a first email message 402 and an embedded second email message 404. For the example format 400, the second email message 404 is embedded in the first email message 402. In some implementations, the second email message 404 is an attachment to the first email message 402.

As shown in FIG. 4, the first email message 402 includes a first header 406 (header 1), an account ID 408 for the payee and the embedded second email message 404. The second email message 404 includes a second header 410 (header 2) and an encrypted payment token 412. The second header 410 includes a To: address of the payment issuing financial institution server computer 102. The first header 406 includes a To: address of mobile wallet service provider server computer 104. The account ID 408 of the payee permits mobile wallet service provider server computer 104 to determine financial account information for the payee. The financial account information can include a financial institution at which the payee has at least one financial account and an identifier for the financial account. As discussed earlier herein, the identity of the financial institution of the payee can determine a mechanism for completing payment to the payee. When the financial institution of the payee is the same as the financial institution of the payer, the funds transfer can be completed directly on payment issuing financial institution server computer 102. However, when the financial institution of the of the payee is different than the financial institution of the payer, the funds transfer is completed by an ACH payment between payment issuing financial institution server computer 102 and payment receiving financial institution server computer 116.

An example of the first header 406 can be:
To: walletprovider@wallet.gmail.com
From: payee@wallet.msn.com
Subject: Payment Request

An example of second header 410 can be:
To: accountservices@wellsfargo.com
From: walletprovider@wallet.gmail.com
Subject: Payment Request

The account ID 406 can be encrypted with a public key of the wallet.gmail.com service provider. The second email message 404 can also be encrypted with the public key of the wallet.gmail.com service provider. As discussed earlier herein, the encrypted payment token 412 can comprise the payment token encrypted with the session key.

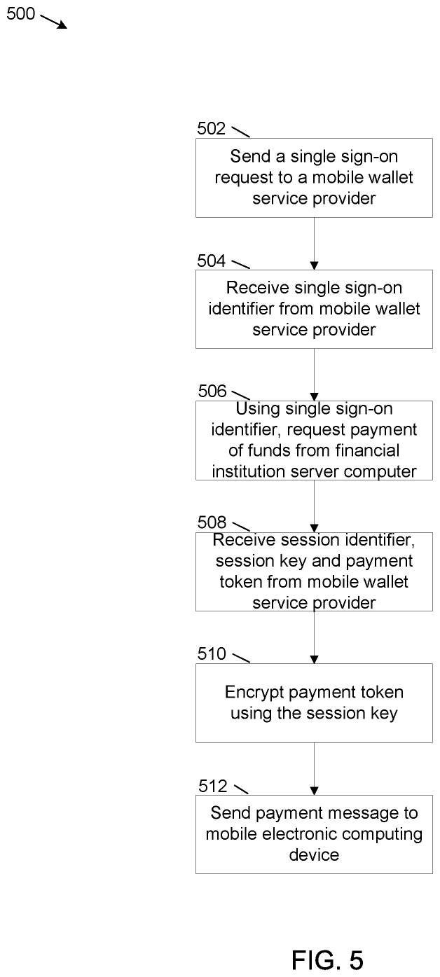

FIG. 5 shows a flowchart of an example method 500 for initiating a transfer of funds from a mobile electronic computing device of a payer (for example from mobile electronic computing device 106). The funds transfer is implemented via a digital wallet client (for example wallet client 110) on the mobile electronic computing device of the payer (for example mobile electronic computing device 106). The funds transfer makes use of a federated single sign-on system that includes the mobile electronic computing device of the payer, a mobile electronic computing device of a payee (for example mobile electronic computing device 108), a server computer of a mobile wallet service provider (for example mobile wallet service provider server computer 104) a server computer at which the payer has a financial account (for example payment issuing financial institution server computer 102) and a server computer at which the payee has a financial account (for example payment issuing financial institution server computer 102 or payment receiving financial institution server computer 116).

At operation 502, a single sign-on request is sent to the mobile wallet service provider. For the example method 500, the mobile wallet service provider, the mobile electronic computing devices of the payer and the payee, a server computer at which the payer has a financial account and the server computer at which the payee has a financial account are all part of a federated single sign-on system. The single sign-on system permits the payer to access mobile wallet service provider server computer 104 and payment issuing financial institution server computer 102 with a same single sign-on identifier. The single sign-on request can include a user ID and a password for the payer or some other form of unique identification that authenticates the payer at the mobile wallet service provider and the payment issuing financial institution server computer 102.

At operation 504, a single sign-on identifier is received from the mobile wallet service provider. The single sign-on identifier is unique identifier that can authenticate the payer at all computing devices in the federated single sign-on system. In some implementations, the single sign-on identifier can be a user ID and password used by the payer at payment issuing financial institution server computer 102. In other implementations, the single sign-on identifier can be any other unique identifier that is provided by the mobile wallet service provider when the payer is authenticated at the mobile wallet service provider.

At operation 506, the single sign-on identifier is used to request a payment of funds from payment issuing financial institution server computer 102 to a third party. The request specifies a dollar amount that is request to be transferred to the third party. For method 500, the third party is the payee at mobile electronic computing device 108.

At operation 508, a session key and a payment token are received from the mobile wallet service provider. The session key provides a unique number that can be used to encrypt the payment token. The payment token provides an authorization from the financial institution of the payer to authorize the funds transfer for the requested dollar amount. The session key and payment token are sent from the mobile wallet service provider based on a payment authorization from payment issuing financial institution server computer 102. In some implementations, the session key may be sent separately from the session identifier and payment token. In some implementations, the mobile wallet service provider can use the single sign-on identifier as a session identifier.

At operation 510, the payment token is encrypted using the session key.

At operation 512, a payment message is sent from the mobile electronic computing device 106 to mobile electronic computing device 108. The payment message includes the encrypted payment token and account management address information for the financial institution of the payer. The account management identification information can include an identifier for the financial institution of the payer and an identifier for a financial account of the payer from which funds are to be transferred. The identifier for the financial institution of the payer can include one or more of an address of the financial institution of the payer, a URL of a website of the financial institution of the payer and an email address of the financial institution of the payer. Other account management identification information is possible.

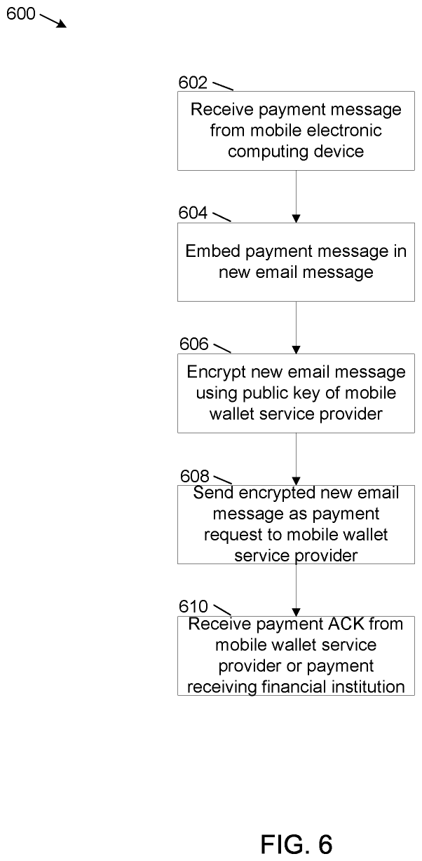

FIG. 6 shows a flowchart of an example method 600 for processing a payment message for a funds transfer received at the mobile electronic computing device of the payee (for example at mobile electronic computing device 108).

At operation 602, the payment message is received from mobile electronic computing device 106. As stated above, the payment message includes the encrypted payment token and account management address information for the financial institution of the payer.

At operation 604, the payment message is embedded in or inserted as an attachment to a new email message.

At operation 606, the new email message is encrypted using a public key of the mobile wallet service provider.

At operation 608, the encrypted new email message is sent to the mobile wallet service provider server computer 104. As a result, the mobile wallet service provider sends a payment request to the payment issuing financial institution server computer 102.

At operation 610, a payment acknowledgment is received from either the mobile wallet service provider or from the payment receiving financial institution. The payment acknowledgement is received from the mobile wallet service provider when the financial institution of the payer and the payee are the same. The payment acknowledgement is received from the payment receiving financial institution when the financial institution of the payer and the payee are different.

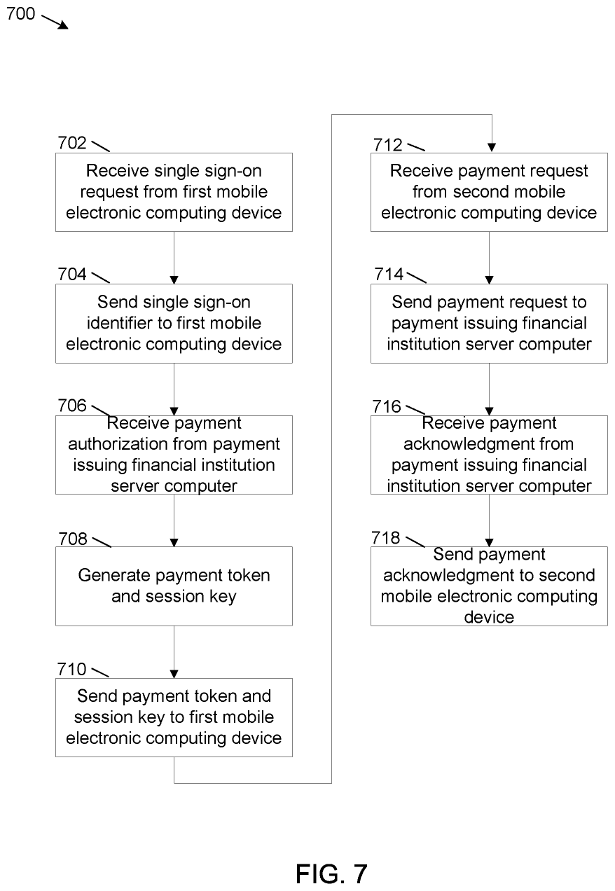

FIG. 7 shows a flowchart of an example method 700 for processing a funds transfer request at the mobile wallet service provider (for example at mobile wallet service provider server computer 104).

At operation 702, a single sign-on request is received from mobile electronic computing device 106, the mobile electronic computing device of the payer.

At operation 704, the mobile wallet service provider sends a single sign-on identifier to mobile electronic computing device 106. The single sign-on identifier is an identifier that authenticates the payer to access any electronic computing device that participates in single sign-on in a federated single sign-on program operational at the mobile wallet service provider.

At operation 706, a payment authorization for the funds transfer is received from payment issuing financial institution server computer 102. The payment authorization is received as a result of a funds transfer request (operation 506 of FIG. 5) sent by the payer to payment issuing financial institution server computer 102.

At operation 708, the mobile wallet service provider generates a payment token and a session key. The payment token includes information regarding a dollar amount of the funds transfer and provides an authorization for the funds transfer. The session key provides a unique number that can be used to encrypt the payment token. In some implementations, the payment issuing financial institution server computer 102 generates the payment token.

At operation 710, the payment token and session key are sent to mobile electronic computing device 106. As discussed earlier herein, mobile electronic computing device 106 encrypts the payment token with the session key (operation 510 of FIG. 5) and sends the encrypted payment token to mobile electronic computing device 108 (operation 512 of FIG. 5). Mobile electronic computing device 108 then embeds or attaches the encrypted payment token to an email message, encrypts the email message and sends a payment request to the mobile wallet service provider (operations 604-608 of FIG. 6).

At operation 712, the payment request from mobile electronic computing device 108 is received at the mobile wallet service provider.

At operation 714, the mobile wallet service provider sends the payment request to the payment issuing financial institution server computer 102. The mobile wallet service provider decrypts the payment request email using a private key of the mobile wallet service provider. The mobile wallet service provider then appends the account identifier of the payee to the encrypted payment token and encrypts a new email comprising the account identifier of the payee and the encrypted payment token using a public key of the payment issuing financial institution server computer 102. The mobile wallet service provider then sends the new email to payment issuing financial institution server computer 102.

At operation 716, a payment acknowledgment is received from payment issuing financial institution server computer 102. The payment acknowledgment is received at the mobile wallet payment provider when the financial institution of the payer and the payee are the same.

At operation 718, the mobile wallet payment provider sends the payment acknowledgment to mobile electronic computing device 108.

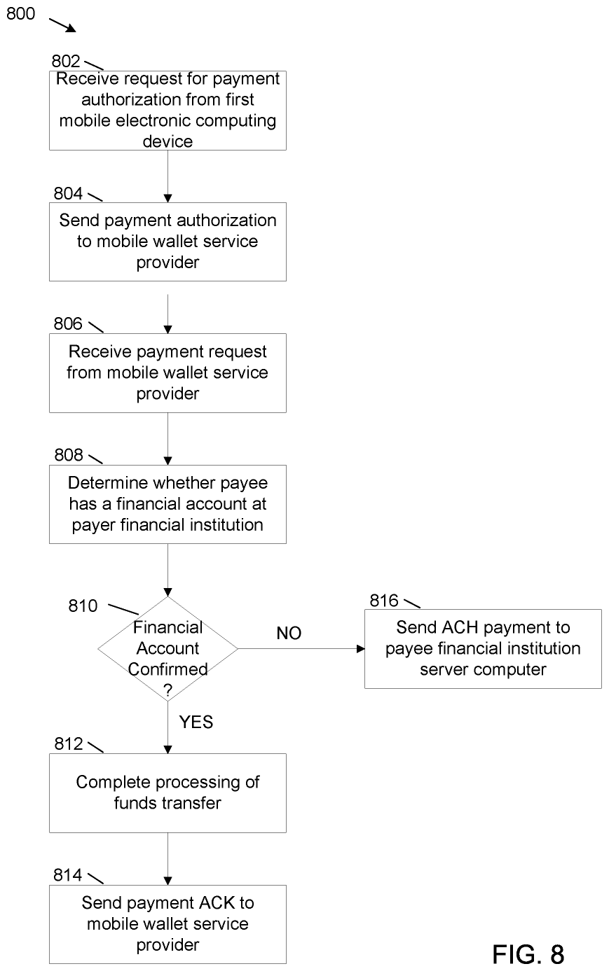

FIG. 8 shows a flowchart of an example method 800 for processing a funds transfer request at the financial institution server computer of the payer (payment issuing financial institution server computer 102).

At operation 802, a request is received at payment issuing financial institution server computer 102 from mobile electronic computing device 106 to authorize a funds transfer from a financial account of the payer.

At operation 804, a payment authorization for the funds transfer is sent to the mobile wallet service provider. In some implementations, the payment authorization can include a payment token. In other implementations, the payment token is generated by the mobile wallet service provider.

At operation 806, a payment request is received from the mobile wallet service provider. The payment request, per operation 714 of FIG. 7, includes the account identifier of the payee and the encrypted payment token.

At operation 808, a determination is made as to whether the payee has a financial account at the payer financial institution.

At operation 810, when a determination is made that payee does have a financial account at the financial institution of the payer, at operation 812, payment issuing financial institution server computer 102 completes processing of the funds transfer. This can include debiting the payer financial account for the dollar amount of the funds transfer and crediting the payee financial account for the dollar amount of the funds transfer.

At operation, 814, a payment acknowledgment is sent to the mobile wallet service provider.

At operation 810, when a determination is made that the payee does not have a financial account at the financial institution of the payee, at operation 816, an ACH payment is sent to the payee financial institution server computer, for example to payment receiving financial institution server computer 116.

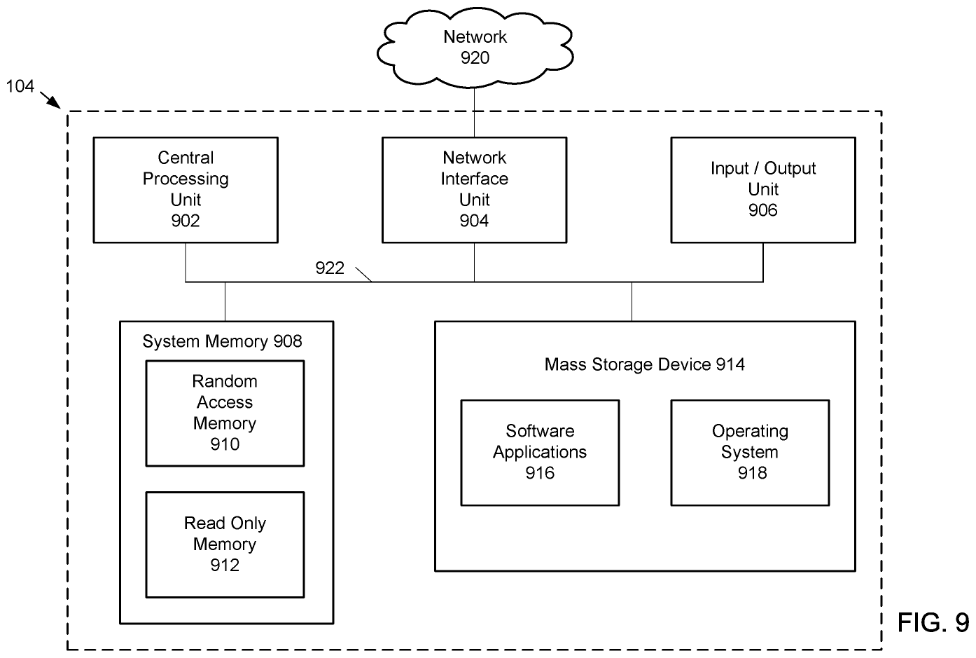

As illustrated in the example of FIG. 9, mobile wallet service provider server computer 104 includes at least one central processing unit (“CPU”) 902, a system memory 908, and a system bus 922 that couples the system memory 908 to the CPU 902. The system memory 908 includes a random access memory (“RAM”) 910 and a read-only memory (“ROM”) 912. A basic input/output system that contains the basic routines that help to transfer information between elements within the mobile wallet service provider server computer 104, such as during startup, is stored in the ROM 912. The mobile wallet service provider server computer 104 further includes a mass storage device 914. The mass storage device 914 is able to store software instructions and data. Some or all of the components of the mobile wallet service provider server computer 104 can also be included in payment issuing financial institution server computer 102, mobile electronic computing device 106 and mobile electronic computing device 108.

The mass storage device 914 is connected to the CPU 902 through a mass storage controller (not shown) connected to the system bus 922. The mass storage device 914 and its associated computer-readable data storage media provide non-volatile, non-transitory storage for the mobile wallet service provider server computer 104. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the mobile wallet service provider server computer 104.

According to various embodiments of the invention, the mobile wallet service provider server computer 104 may operate in a networked environment using logical connections to remote network devices through the network 920, such as a wireless network, the Internet, or another type of network. The mobile wallet service provider server computer 104 may connect to the network 920 through a network interface unit 904 connected to the system bus 922. It should be appreciated that the network interface unit 904 may also be utilized to connect to other types of networks and remote computing systems. The mobile wallet service provider server computer 104 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the mobile wallet service provider server computer 104 can store software instructions and data. The software instructions include an operating system 918 suitable for controlling the operation of the mobile wallet service provider server computer 104. The mass storage device 914 and/or the RAM 910 also store software instructions, that when executed by the CPU 902, cause the mobile wallet service provider server computer 104 to provide the functionality of the mobile wallet service provider server computer 104 discussed in this document. For example, the mass storage device 914 and/or the RAM 910 can store software instructions that, when executed by the CPU 902, cause the mobile wallet service provider server computer 104 to display received data on the display screen of the mobile wallet service provider server computer 104.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on a first server computer for processing an electronic payment from a first user to a second user, the method comprising:
receiving, at the first server computer that is associated with a financial institution, a first request from a first electronic computing device to initiate a process for making the electronic payment from the first user at the first electronic computing device to the second user at a second electronic computing device;
sending a payment authorization from the first server computer to a second server computer, the payment authorization specifying a dollar amount of the electronic payment, wherein the second server computer is associated with a digital wallet client, and wherein the second server computer uses the payment authorization to generate a payment token for the dollar amount specified in the payment authorization, wherein the payment token authorizes the electronic payment;
receiving, at the first server computer, a second request from the second server computer to process the electronic payment, the second request including the payment token received from the second electronic computing device and a financial account identifier for the second user;
obtaining the dollar amount of the electronic payment from the payment token;
obtaining a session identifier at the first server computer;
determining whether the session identifier is an identifier for an active session;
determining whether the financial account identifier for the second user is for a financial account at a first financial institution associated with the first server computer; and
when a determination is made that the session identifier is an identifier for an active session and when a determination is made that the financial account identifier for the second user is for the financial account at the first financial institution associated with the first server computer, crediting the dollar amount of the electronic payment to the financial account for the second user at the first financial institution.

2. The method of claim 1, further comprising:
when a determination is made that the financial account identifier for the second user is not for the financial account at the first financial institution and a determination is made that the session identifier is active, send a third request to process the payment token to a third server computer associated with a second financial institution at which the second user has one or more financial accounts.

3. The method of claim 1, further comprising:
when a determination is made that the session identifier is not an identifier for an active session, cancel the electronic payment.

4. The method of claim 1, further comprising:
generating the payment token; and
sending the payment token in the payment authorization.

5. The method of claim 1, further comprising:
generating the session identifier; and
sending the session identifier in the payment authorization.

6. The method of claim 5, wherein the session identifier is an active session identifier until the process for making the electronic payment is terminated at the first server computer.

7. The method of claim 1, wherein the first server computer is a part of a federated system that supports a single sign-on (SSO).

8. The method of claim 1, wherein the session identifier is an identifier used for a single sign-on to the first server computer.

9. The method of claim 1, further comprising:
processing a single sign-on request at the first server computer, the single sign-on request including the session identifier.

10. The method of claim 9, wherein the session identifier is an active identifier as long as a user is logged in the first server computer as a result of the single sign-on request.

11. The method of claim 1, wherein the payment token included in the second request includes an authorization for the electronic payment.

12. A method implemented on a first electronic computing device for initiating an electronic payment from a first user on the first electronic computing device to a second user on a second electronic computing device, the method comprising:
sending a payment request from the first electronic computing device to a first server computer, wherein the first server computer is associated with a financial institution;
as a result of sending the payment request to the first server computer, receiving, at the first electronic computing device from a second server computer, a session key and a payment token for a dollar amount specified in a payment authorization from the first server to authorize the electronic payment, wherein the second server computer is associated with a digital wallet client; and
sending a payment message from the first electronic computing device to the second electronic computing device to initiate the electronic payment from the first user on the first electronic computing device to the-second user on the second electronic computing device,
wherein the payment message includes the payment token.

13. The method of claim 12, further comprising:
sending a request for a single sign-on identifier to the second server computer; and
including the single sign-on identifier with the payment request to the first server computer.

14. The method of claim 12, wherein the first electronic computing device includes a digital wallet client.

15. The method of claim 12, wherein the payment message comprises an encrypted email message.

16. The method of claim 15, wherein the payment token is encrypted with the session key in the encrypted email message.

17. The method of claim 12, wherein the payment message is sent using near-field communication (NFC).

18. The method of claim 12, wherein the payment token includes an authorization for the electronic payment and a dollar amount of the electronic payment.

19. The method of claim 12, wherein the payment message includes an identifier for a financial institution at which the first user has a financial account.

20. A first server computer comprising:
a processing unit; and
system memory, the system memory including instructions which, when executed by the processing unit, cause the first server computer to:
receive, at the first server computer that is associated with a financial institution, a first request from a first mobile electronic computing device to initiate a process for making an electronic payment from a first user at the first mobile electronic computing device to a second user at a second mobile electronic computing device;
send, from the first server computer, a payment authorization for a dollar amount associated with the electronic payment to a second server computer, wherein the second server generates a payment token for the dollar amount specified in the payment authorization, wherein the payment token authorizes the electronic payment;
receive, at the first server computer, a second request from the second server computer to process the electronic payment, the second request including the payment token and a financial account identifier for the second user;
obtain the payment token from the second request;
obtain the dollar amount of the electronic payment from the payment token;
determine whether the session identifier is an identifier for an active session;
determine whether the financial account identifier for the second user is for a financial account at a first financial institution associated with the first server computer;
when a determination is made that the session identifier is an identifier for an active session and when a determination is made that the financial account identifier for the second user is for the financial account at the first financial institution associated with the first server computer, credit the dollar amount of the electronic payment to the financial account for the second user at the first financial institution;
when a determination is made that the financial account identifier for the second user is not for the financial account at the first financial institution and a determination is made that the session identifier is active, send a third request to process the payment token to a second server computer associated with a second financial institution at which the second user has one or more financial accounts; and
when a determination is made that the session identifier is not an identifier for an active session, cancel the electronic payment.
